(19) United States
(12) Patent Application Publication
(10) Pub. No.: US 2019/0372926 A1
(43) Pub. Date: Dec. 5, 2019

(54) CONTACT RELEVANCE DATA PROVISIONING IN EMAIL SYSTEMS

(71) Applicant: Microsoft Technology Licensing, LLC, Redmond, WA (US)

(72) Inventor: Paul Alan Elliott, Woodinville, WA (US)

(21) Appl. No.: 15/997,323

(22) Filed: Jun. 4, 2018

(51) Int. Cl. H04L 12/58; H04L 29/12; G06F 17/30

(52) U.S. Cl. CPC H04L 51/28; G06F 17/30321; G06F 17/3048; H04L 61/307

(57) ABSTRACT

Techniques of contact relevance data provisioning in an email system are disclosed herein. In one embodiment, an email server is configured to create a database record in a reverse index database indexed to an email address of a received email message. Upon receiving a registration request from a user to register the indexed email address with an email service provided by the email server, the email server can be configured to locate the created database record in the reverse index database using the indexed email address as a key and provision contact relevance data in a recipient cache of the user by copying data in the located database record from the reverse index database to the recipient cache.

### BACKGROUND

Electronic Mail (“email” or “e-mail”) is a technique of exchanging messages between users using computers, smart phones, or other suitable types of electronic devices. Email exchanges operate across computer networks such as the Internet or an intranet. Today's email systems are typically based on a store-and-forward model utilizing email servers to accept, forward, and store email messages. Users or their computers can connect to email servers or webmail interfaces via a computer network to send or receive email messages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An email message typically includes a message header, a message body, and optionally one or more attachments appended to the email message. A message header can include structured data fields individually containing source/destination addresses (e.g., “To:” or “From”), subject, and/or other suitable information describing the email message. A message body can contain data, such as in plain text or Hypertext Markup Language text, representing information conveyed in the email message. Attachments can include Microsoft Word® documents, images, videos, or other suitable types of files.

According to the store-and-forward model of email processing, when an email message is sent via an email server of a sender, a copy of the email message including the email header, the message body, and the one or more optional attachments is first received and stored on the email server in, for example, an “outbox” folder of the sender. Similarly, when an email message is received at the email server, a copy of the email message is first stored on the email server in, for example, an “inbox” folder of a recipient. The email server can then forward a copy of the received/sent email message to a recipient (or the recipient's email server) via a computer network, such as the Internet.

To provide convenience for inputting email addresses of recipients during email composition, certain email systems provide a feature according to which an email server can provide email address suggestions based on accumulated contact relevance data such as email addresses of other users a sender has previously communicated with. For example, the email server can accumulate contact relevance data representing how often (e.g., frequency, a total number, etc.) or how recent (e.g., two days ago or two years ago) the sender has sent and/or received email messages to/from a particular recipient. Based on the accumulated data and/or other suitable criteria, the email server can provide email address suggestions to the sender when or even before the sender starts typing an email address in, for example, a “To:” field in an email client. For instance, if the sender often sends email messages to “jeff” at “jeff@amazon.com,” the email server can provide a suggestion to the sender (e.g., “jeff@amazon.com”) when the sender clicks on the “To:” field in the email client, or when the sender types only an “j” in the “To:” field. The sender can then select the suggested email address (e.g., by clicking on the suggestion or pressing “Enter” on a keyboard) without having to type in the entire email address.

The foregoing convenience, however, may not be available when a sender is new to an email system (e.g., a corporate email system). For example, a sender can be a new user of an email system by, for instance, subscribing to email services provided by the email system, or installing an email client for accessing the email system. As such, there is no or little history of any previous email addresses the sender has communicated with. When the sender starts to use the email services, the email system may be unable to provide any email address suggestions of potential recipients. Only after a period of use (e.g., days or weeks), the email system may then provide the suggestions as described above after accumulated sufficient contact relevance data.

Several embodiments of the disclosed technology can provide little or no delay in providing suggestion of email addresses of potential recipients to new users of an email system or service by implementing a reverse index database for accumulating contact relevance data according to email addresses instead of user identifications. In one implementation, an email server can receive an incoming email message from a non-registered email address destined to another email address corresponding to a registered or non-registered user. Even though the non-registered email address does not belong to any registered user, the email server can still create a reverse index record in a database indexed or keyed to the non-registered email address. In the created reverse index record, data representing one or more of a source/destination email address, a date/time of transmission, a size of the email message, and/or other suitable information of the email message can be recorded. In another implementation, when a registered user of the email services sends an email message to the same non-registered email address, the email server can be configured to create another reverse index record keyed to the non-registered email address by recording data representing various parameters of the email message. Thus, over time, the reverse index database can contain multiple reverse index records indexed or keyed to individual non-registered email addresses.

Subsequently, when a new user registers with the email system or service using the previously non-registered email address, the email system can use the non-registered email address as a key to locate all or a part of entries corresponding to the email address in the reverse index database and copy the corresponding reverse index records to a file location (e.g., a recipient cache) to provision the contact relevance data. The email system can then use the information in the reverse index records to provide email address suggestions of potential recipients without any delay. Thus, when the newly user starts typing in the “To:” filed in an email client immediately after registration, the email system can instantly provide email address suggestions. As such, the newly registered user can enjoy the convenience of email address suggestions without spending a period to accumulate the contact relevance data, thereby improving user experience with the email system or service.

### BRIEF DESCRIPTION OF THE DRAWINGS

FIG. 1 is a schematic diagram illustrating an email system implementing contact relevance data provisioning in accordance with embodiments of the disclosed technology.

FIGS. 2A-2C are schematic diagrams illustrating certain hardware/software components of the email system of FIG. 1 during various stages of contact relevance data provisioning in accordance with embodiments of the disclosed technology.

FIGS. 3A and 3B are schematic diagrams illustrating an example user interface configured to utilize contact relevance data provisioning in accordance with embodiments of the disclosed technology.

FIGS. 4A and 4B are flowcharts illustrating processes of in accordance with embodiments of the disclosed technology.

FIG. 5 is a computing device suitable for certain components of the email system in FIG. 1.

### DETAILED DESCRIPTION

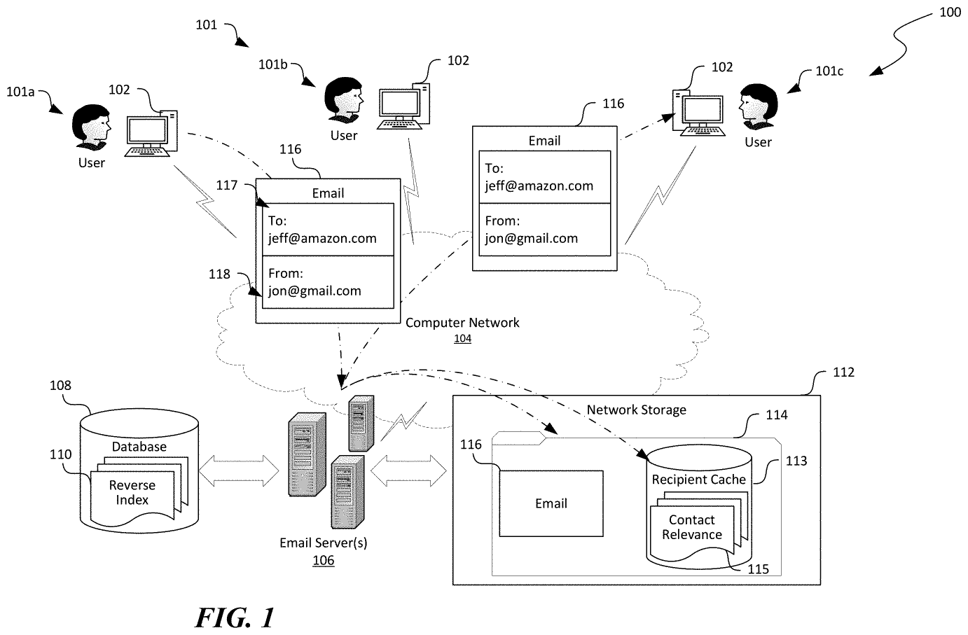

Certain embodiments of systems, devices, components, modules, routines, data structures, and processes for automatic image classification in computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-5.

As used herein, the term “email server” generally refers to computer dedicated to running such applications that are configured to receive incoming emails from senders and forward outgoing emails to recipients via a computer network, such as the Internet. Examples of such applications include Microsoft Exchange®, qmail, Exim, and sendmail. An email server can maintain and/or access one or more inboxes for corresponding users. As used herein, an “inbox” is a file folder configured to contain data representing incoming emails for a user. The email server can also maintain and/or access one or more outboxes configured to contain outgoing emails and/or other suitable mailboxes. Also used herein, a “recipient cache” generally refers to a file holder that contains records of contact relevance data of a user. In certain implementations, a recipient cache can be located on an email server. In other implementations, a recipient cache can be located on a client device and on an email server. In further implementations, a recipient cache can be located on a client device of the user alone.

Also used herein, the term “contact relevance data” generally refers to data representing contact information of one or more of a person, an organization, a group, a department, a team, or other suitable types of entity that a user has communicated with. In one example, contact relevance data can include data records of email addresses, phone numbers, instant message aliases, social network aliases, or other suitable contact data according to which a user can communicated with other users. Contact relevance data can also include time stamps, a number of messages per period, or other suitable parameters associated with the previous communications. In one particular example, a record of contact relevance data of a user can include one or more email addresses of other users the user has communicated with previously.

In certain implementations, contact relevance data can be organized and stored in a “forward index” database in which contact data of other users a user communicated with previously are indexed or keyed according to an identification of the user. Thus, a search based on the identification of the user can locate contact relevance data of all communications to/from the user. In accordance with embodiments of the disclosed technology, contact relevance data can also be stored in a “reverse index” database in which entries are indexed or keyed to an email address, a phone number, an instant message alias, or other suitable types of contact data. Data in each entry can represent a source or destination from/to which communications has been received/transmitted. For example, a record in the reverse index database can be indexed, keyed, or otherwise identified by an email address and include data that represents one or more other email addresses, user identifications, or other suitable information the indexed email address has either received an email message from or transmitted an email message to.

Further used herein, a “registered user” generally refers to a user who has created a user account with a computing service (e.g., email service provided by one or more email servers in a corporation) by providing, inter alia, information such as user name, contact information, communications preferences, or other suitable types of information. A “registered email address” is an email address that has a corresponding registered user in an email system. On the other hand, a “non-registered email address” is an email address that does not have a corresponding registered user with an account in an email system. For example, a user who is an employee of a company (e.g., Jeff Bezos) is a registered user to an email service of Amazon.com. An email address of Jeff Bezos (e.g., “jeff@amazon.com”) is a registered email address to the email service of Amazon.com. On the other hand, an email address from a different domain, organization, etc., (e.g., “jon@gmail.com”) can be a non-registered email address to the email system at Amazon.com.

Certain email systems can provide a convenience feature to users by offering email address suggestions (or other suitable types of communications addresses) of potential recipients when a user starts typing in a destination address. The user can then select one or more of the suggested email addresses to efficiently complete an email message. Such a convenience feature, however, depends on accumulation of contact relevance data such as email addresses of other users the user has previously communicated with. As such, when a user is a new user to the email service, this convenience feature may not be available for a lack of accumulated contact relevance data.

Several embodiments of the disclosed technology can provide email suggestions of potential recipients for new users with little or no delay by implementing a reverse index database for accumulating contact relevance data of non-registered email addresses. Subsequently, when a new user registers with the email service using the previously non-registered email address, the email server can use the non-registered email address as a key to locate all or a part of entries in the reverse index database and copy the corresponding reverse index records from the database to a file location (e.g., a recipient cache) of the new user to provision the contact relevance data. Thus, when the newly user starts using the email service, for instance, by typing in the “To:” filed in an email client, the email system can instantly provide email address suggestions of potential recipients based on the copied reverse index records. As such, the newly registered user can enjoy the convenience of email address suggestions without having to wait for a period to accumulate the contact relevance data, as described in more detail below with reference to FIGS. 1-5.

FIG. 1 is a schematic diagram illustrating an email system 100 implementing contact relevance data provisioning in accordance with embodiments of the disclosed technology. As shown in FIG. 1, the email system 100 can include a computer network 104 interconnecting client devices 102 and one or more email servers 106 (referred to as “email server 106” here in for simplicity). The email server 106 is also interconnected with a network storage 112 containing one or more inboxes 114 (only one is shown for clarity) and a reverse index database 108 containing one or more reverse index records 110. The computer network 104 can include an intranet, a wide area network, the Internet, or other suitable types of network. Even though particular components of the email system 100 are shown in FIG. 1, in other embodiments, the email system 100 can also include additional and/or different components or arrangements. For example, in certain embodiments, the email system 100 can also include additional network storage devices, additional servers, and/or other suitable components (not shown). In other embodiments, the network storage 112 and/or the reverse index database 108 may be integrated into the email server 106.

The client devices 102 can each include a computing device that facilitates corresponding users 101 (shown as “User A 101a,” “User B 101b,” and “User C, 101c”) to access email and other suitable types of computing services provided by the email server 106 via the computer network 104. For example, in the illustrated embodiment, the client devices 102 individually include a desktop computer. In other embodiments, the client devices 102 can also include laptop computers, tablet computers, smartphones, or other suitable computing devices. Even though three users 101 are shown in FIG. 1 for illustration purposes, in other embodiments, the email system 100 can facilitate any suitable number of users 101 to access suitable types of computing services provided by the email server 106.

The email server 106 can be configured to facilitate email reception, storage, forwarding, and other related functionalities. For example, as shown in FIG. 1, the first user 101a can utilize the client device 102 to generate and transmit an email 116 to the third user 101c via the email server 106 and optionally other interconnected email servers (not shown). The email 116 is destined to the third user 101c and can include an email header with a destination address field 117 and a source address field 118, an email body (not shown), and one or more optional attachments (not shown). In the illustrated example, the destination address field 117 contains an email address “jeff@amazon.com” while the source address field 118 contains an email address “jon@gmail.com.” In other examples, the destination address field 117 can include multiple email addresses (not shown).

Upon receiving the email 116 from the first user 101a, the email server 106 can store a copy of the email 116 in an inbox 114 on the network storage 112 that correspond to the third user 101c. Subsequently, the email server 106 can forward a copy of the email 116 to the client device 102 of the third user 101c. Even though the email server 106 is described above as being configured to facilitate storing and forwarding emails 116 for both the first and third users 101a and 101c, in other embodiments, additional email servers (not shown) may be utilized to separately facilitate similar functionalities for the first and third users 101a and 101c.

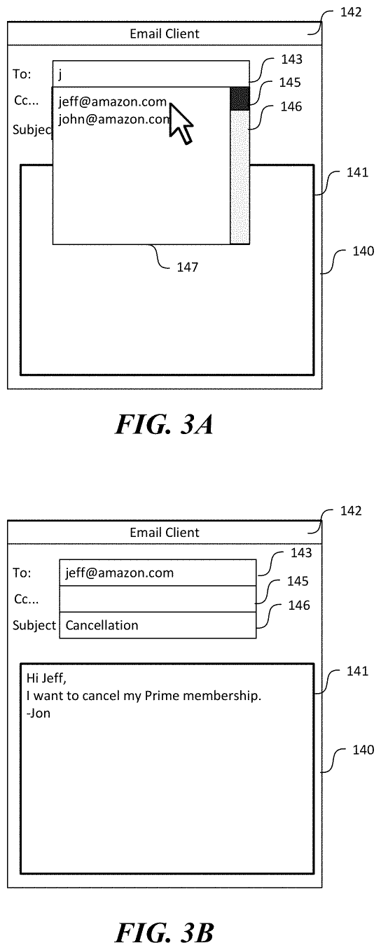

As shown in FIG. 1, the email server 106 can also be configured to update records of contact relevance data 115 in a recipient cache 113 corresponding to the third user 101c. For example, the email server 106 can create a new record indicating that the third user 101c has received an email from “jon@gmail.com” at certain date/time, etc. As such, when the third user 101c next composes an email to “jon@gmail.com,” the email server 106 can provide a suggestion of this email address when the third user 101c types a “j” in a destination address field 143 (shown in FIG. 3A) or even before the third user 101c types anything in the destination address field 143, for example, by providing email addresses that the third user 101c communicated with most often, most recent, or based on other suitable criteria.

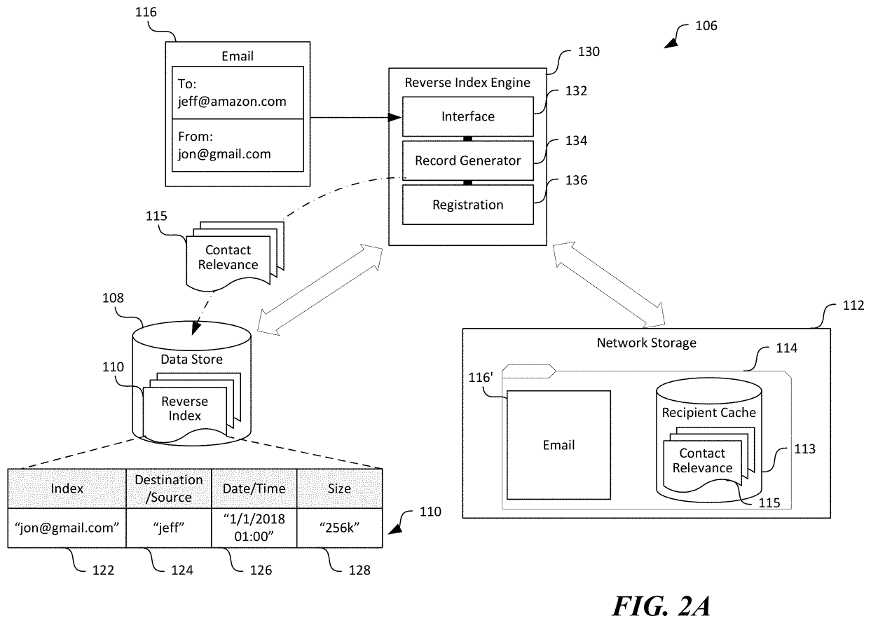

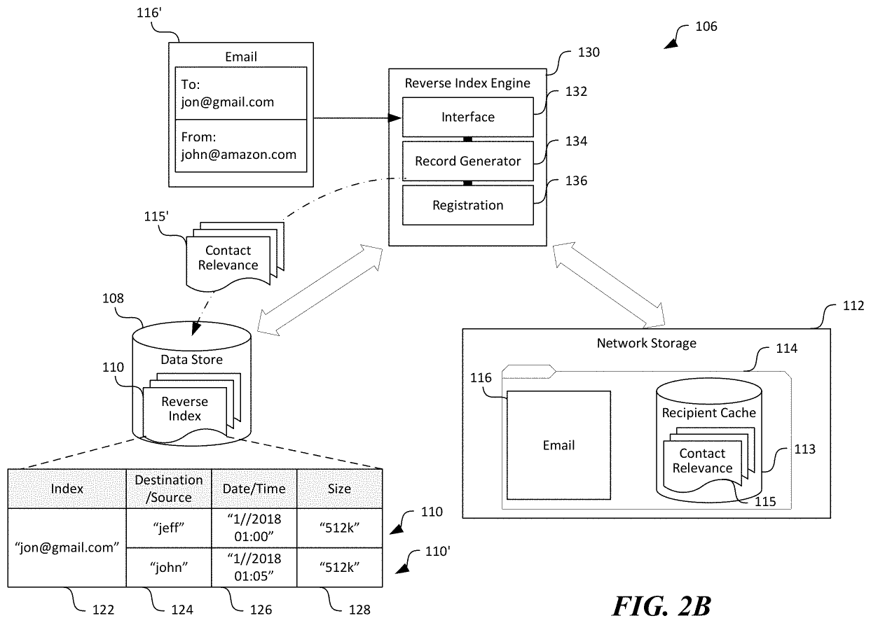

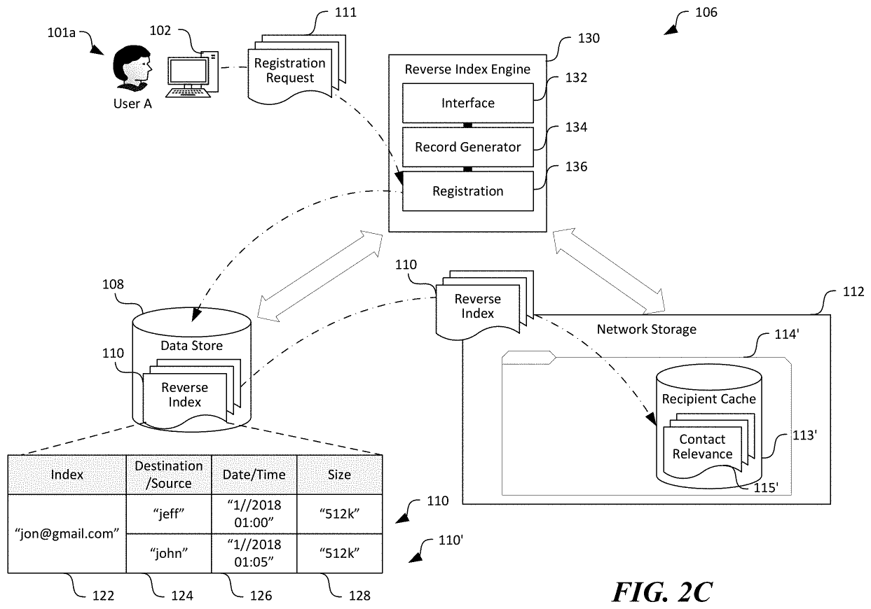

In accordance with embodiments of the disclosed technology, the email server 106 can also include a reverse index engine 130 (shown in FIG. 2A) that is configured to create and accumulate records of contact relevance data in a reverse index database 108 for non-registered email addresses. For instance, in the illustrated example, the source email address “jon@gmail.com” may not be a registered email address and the first user 101a may not be a registered user in the “amazon.com” domain. The first user 101a, however, may later decide to register with the “amazon.com” domain. Upon registration of the first user 101a, the email server 106 can be configured to enable contact relevance data provisioning to the first user 101a, such that the first user 101a can enjoy the convenience of suggested email addresses of potential recipients, as described in more detail below with reference to FIGS. 2A-2C.

FIGS. 2A-2C are schematic diagrams illustrating certain hardware/software components of the email system 100 during various stages of contact relevance data provisioning in accordance with embodiments of the disclosed technology. In FIGS. 2A-2C, only certain components of the email system 100 of FIG. 1 are shown for clarity. In FIG. 2A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2A, the reverse index engine 130 can include an interface component 132, a record generator 134, and a registration component 136 operatively coupled to one another. In certain embodiments, the reverse index engine 130 can be a part of the email server 106. In other embodiments, the reverse index engine 130 can be a standalone application, or a computing service provided by, for instance, another server (not shown). Even though only the foregoing components are shown for illustration purposes in FIG. 2A, in other embodiments, the reverse index engine 130 can also include a computer network component or other suitable types of component.

The interface component 132 can be configured to detect an incoming or outgoing email message 116 to/from the email server 106. For example, as shown in FIG. 2A, the interface component 132 can detect that the email message 116 from the first user 101a (FIG. 1) and destined to the third user 101c has been received. In response, the interface component 132 can identify one or more of a source email address, a destination email address, a date/time of reception, a size (e.g., in kilobytes), or other suitable parameters of the email message 116. The interface component 132 can then forward the identified parameters of the email message 116 to the record generator 134 for further processing.

The record generator 134 can be configured to generate a reverse index record 110 of contact relevance data 115 in the reverse index database 108 for email addresses that are non-registered. For instance, in the illustrated example in FIG. 2A, the reverse index engine 130 can be configured to determine that the source email address, i.e., “jon@gmail.com” is non-registered. In response, record generator 134 can be configured to create a record 110 indexed to the non-registered email address. As shown in FIG. 2A, the example record 110 can include multiple data fields including, for instance, an index field 122, a destination/source field 124, a date/time field 126, and a size field 128. In the illustrated example, the created record 110 can contain “jon@gmail.com,” “jeff,” “Jan. 1, 2018 01:00,” and “256 k” in the corresponding fields 122, 124, 126, and 128. In other examples, the created record 110 can include additional and/or different fields (not shown).

In the illustrated example in FIG. 2B, the reverse index engine 130 can be configured to determine that the destination email address, i.e., “jon@gmail.com” is non-registered in another email massage 116′ from a registered user “John.” In response, the record generator 134 can be configured to create another record 110′ indexed to the non-registered email address, i.e., “jon@gmail.com” by providing suitable contact relevance data 115′. As shown in FIG. 2B, the example record 110′ can contain “jon@gmail.com,” “john,” “Jan. 1, 2018 01:05,” and “512 k” in the corresponding fields 122, 124, 126, and 128. As such, by using the reverse index engine 130, the email server 106 can accumulate records 110 of contact relevance data indexed to a particular non-registered email address instead of a registered user.

In accordance with embodiments of the disclosed technology, using the accumulated records 110 of contact relevance data, the email server 106 can be configured to provide immediate email address suggestions of potential recipients when a previously non-registered user 101 (FIG. 1) registers with the email server 106. For example, as shown in FIG. 2C, the first user 101a can utilize the client device 102 (e.g., via a web browser) to provide a registration request 111 to the email server 106. The registration request 111 can contain data representing a previously non-registered email address, such as “jon@gmail.com.”

In response, the registration component 136 can be configured to query the reverse index records 110 in the reverse index database 108 using the “jon@gmail.com” as an index key. In response to locating at least one record 110, the registration component 136 can be configured to copy the queried reverse index records 110 into the recipient cache 113′ in an email folder 114′ corresponding to the first user 101a on the email server 106 as contact relevance data 115′. The email server 106 can then utilize the contact relevance data 115′ to provide email address suggestions of potential recipients to the first user 101a without the first user 101a waiting for a period (e.g., days or weeks) to accumulate sufficient contact relevance data 115′, as described in more detail below with reference to FIGS. 3A and 3B.

FIGS. 3A and 3B are schematic diagrams illustrating an example user interface 140 configured to facilitate email address suggestions based on contact relevance data in accordance with embodiments of the disclosed technology. As shown in FIG. 3A, the user interface 140 can include an user interface of an email client 142. In the illustrated example, the email client 142 can include a “To:” input field 143 configured to receive a destination email address, a “Cc..” input field 145 configured to receive additional destination email addresses, and a “Subject” input field 146 configured to receive a text string representing a subject of an email message, and a body section 141 configured to receive a message body. In other examples, the email client 142 can include additional and/or different input fields.

As shown in FIG. 3A, when composing an email message, the first user 101a (FIG. 2C) can start typing in the “To:” input field 143, for example, “j.” In response, the email server 106 (FIG. 2C) can provide email address suggestions of potential recipients based on the copied reverse index records 110 (FIG. 2C). For example, as shown in FIG. 3A, upon detecting that a “j” is input into the “To:” input filed 143, based on the copied reverse index records 110, the email server 106 can determine that both “jeff” and “john” may be potential recipients because their names both start with an “j.” In response, the email server 106 can cause a dropdown menu 147 showing email addresses of both “jeff” and “john,” i.e., “jeff@amazon.com” and “john@amazon.com.”

The first user 101a can then select one or more of the suggested email addresses without typing in the entire email address of a recipient. For example, as shown in FIG. 3A, the first user 101a can select (as represented by the cursor) the email address of “jeff.” In response, as shown in FIG. 3B, the corresponding email address, i.e., “jeff@amazon.com” can be automatically populated in the “To:” input field 143. As such, even though the first user 101a may be a brand new user to the computing services provided by the email server 106, the first user 101a can still enjoy the convenience of suggested email addresses of potential recipients without waiting for accumulation of the contact relevance data 115′.

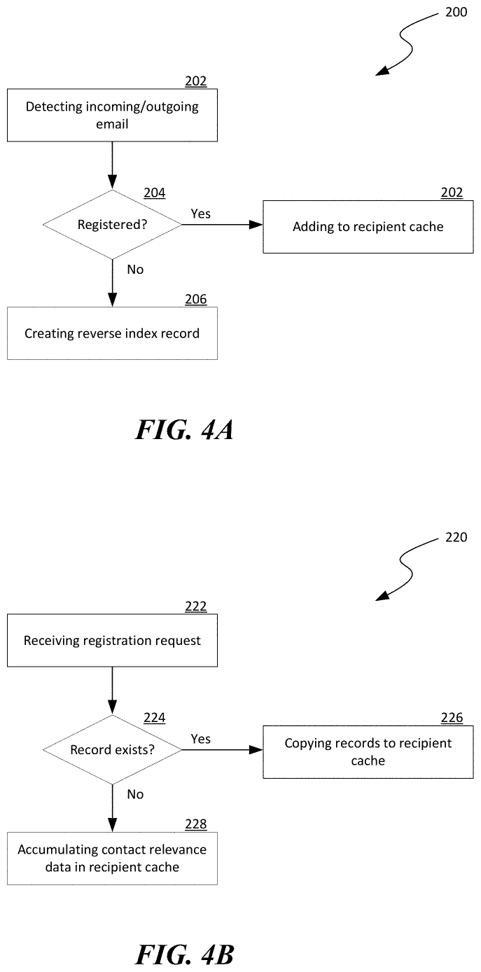

FIGS. 4A and 4B are flowcharts illustrating a process 200 of contact relevance data provisioning in accordance with embodiments of the disclosed technology. Even though embodiments of the process 200 are described below with reference to the email system 100 of FIGS. 1-2C, in other embodiments, the process 200 may be implemented in other computing systems with different components and/or arrangements.

As shown in FIG. 4A, the process 200 can include detecting an incoming or outgoing email at stage 202. The process 200 can then include a decision stage to determine whether any of the source or destination email addresses in the detected email is registered. In certain embodiments, a registered email address has a corresponding user identification or other suitable types of identification. In other embodiments, an email address can be deemed registered based on other suitable criteria. In response to determining that an email address is registered, the process 200 can include adding the other email addresses in the detected email to a recipient cache corresponding to the registered email address. Otherwise, the process 200 can include creating a reverse index record for a non-registered email address at stage 206. The reverse index record can include an index field containing the non-registered email address and other data fields containing one or more of a source/destination email address, a date/time of reception/transmission, a size, or other suitable information of the detected email. The created reverse index record can then be stored in a data store.

FIG. 4B is a flowchart illustrating another process 220 of contact relevance data provisioning. As shown in FIG. 4B, the process 220 can include receiving a registration request for registering a previously non-registered email address with, for example, an email server or service, at stage 222. In response to receiving the registration request, the process 220 can include a decision stage to determine whether any reverse index record exists for the previously non-registered email address. In one embodiment, the determination can include querying a database containing reverse index records using the previously non-registered email address as a key. When one or more reverse index records are found using the previously non-registered email address as a key, the process 220 can include copying the located reverse index records to a recipient cache corresponding to the now registered email address and using information in the reverse index records to provide email address suggestions of potential recipients. When no reverse index record is found, the process 220 can include accumulating contact relevance data in the recipient cache at stage 228. In other embodiments, the determination can also include looking up a table in the database using the email address as a key or via other suitable techniques.

Even though the disclosed technology is described above in the context of email communications, in other implementations, the same or similar techniques may also be applied to other forms of communications. For instance, instead of email addresses, a reverse index record 110 (FIG. 1) may also be created based on phone numbers, instant message aliases, social network aliases, or other suitable identifiers of communications endpoints. As such, embodiments of the disclosed technology are not limited to email systems.

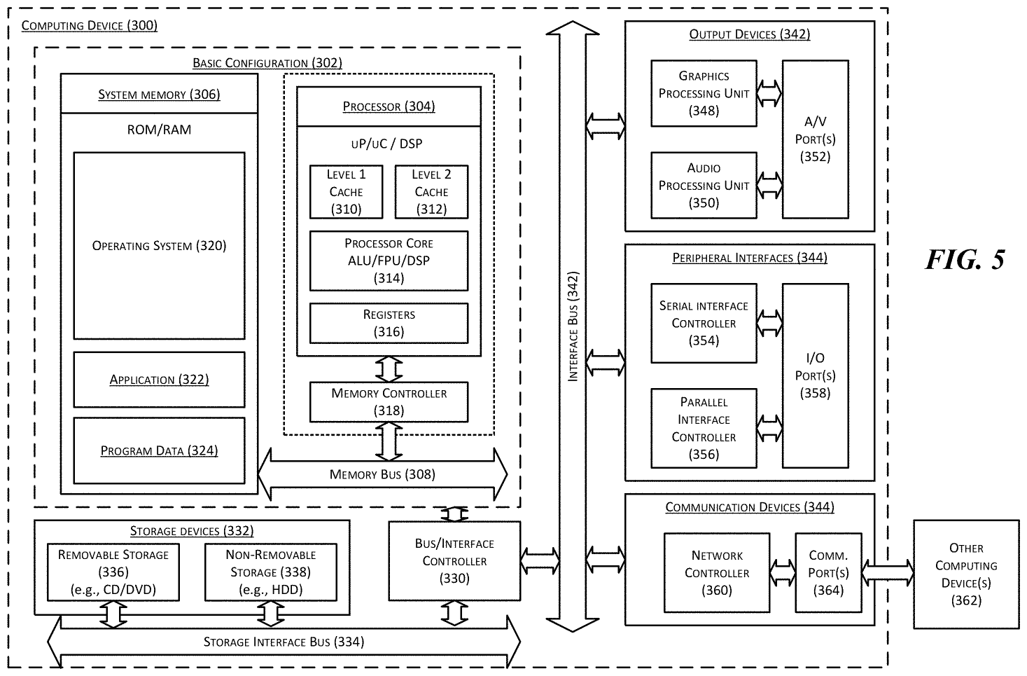

FIG. 5 is a computing device 300 suitable for certain components of the distributed email system 100 in FIG. 1. For example, the computing device 300 can be suitable for the email server 106 or the client devices 102 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for contact relevance data provisioning in an email system having one or more email servers interconnected by a computer network, the method comprising:
detecting, at an email server of the email system, reception of an email message;
in response to detecting the reception of the email message, at the email server, creating a record in a reverse index database indexed to an email address of the detected email message, the record also containing one or more additional email addresses also contained in the detected email message; and
upon receiving, at the email server, a registration request from a user to register the email address with an email service provided by the email server,
querying for one or more records in the reverse index database using the email address as a key;
copying the queried one or more records from the reverse index database to a recipient cache of the user as contact relevance data; and
providing an email address suggestion to the user during email composition by searching for one or more suggested email addresses in the contact relevance data in the recipient cache, thereby reducing or eliminating delay in providing the email address suggestion.

2. The method of claim 1 wherein:
the detected email message contains (i) the email address as a source email address and (ii) a destination email address with a corresponding user in the email system, the source email address does not have a corresponding user in the email system; and
creating the record includes creating the record in the reverse index database indexed to the source email address of the detected email message, the record also containing one or more of the destination email address or an identification of the corresponding user of the destination email address.

3. The method of claim 1 wherein:
the detected email message contains (i) the email address as a destination email address and (ii) a source email address with a corresponding user in the email system, the destination email address does not have a corresponding user in the email system; and
creating the record includes creating the record in the reverse index database indexed to the destination email address of the detected email message, the record also containing one or more of the source email address or an identification of the corresponding user of the source email address.

4. The method of claim 1 wherein:
the detected email message contains (i) the email address as a source email address and (ii) a destination email address, neither the source email address nor the destination email address have a corresponding user in the email system; and
creating the record includes:
creating a first record in the reverse index database indexed to the source email address of the detected email message, the first record also containing the destination email address; and
creating a second record in the reverse index database indexed to the destination email address of the detected email message, the second record also containing the source email address.

5. The method of claim 1 wherein:
the detected email message is a first email message; and
the method further includes:
detecting, at the email server, reception of a second email message also containing the email address; and
in response to detecting the reception of the second email message, at the email server, updating the created record in the reverse index database indexed to the email address one or more other email addresses contained in the detected second email message.

6. The method of claim 1 wherein querying for one or more records includes:
determining whether a record indexed, keyed, or identified by the email address exists in the reverse index database;
in response to determining that a record indexed, keyed, or identified by the email address exists in the reverse index database, retrieving data representing the one or more additional email addresses in the record from the reverse index database.

7. The method of claim 1 wherein providing the email address suggestion includes:
detecting a user input to a destination address field in an email client interconnected to the email server; and
in response to detecting the user input,
outputting, on the email client, the suggested email address that the user communicated with most often or most recent.

8. The method of claim 1 wherein providing the email address suggestion includes:
detecting a user input to a destination address field in an email client interconnected to the email server, the user input includes one or more characters; and
in response to detecting the user input,
searching the recipient cache to locate one or more email addresses containing the one or more characters; and
outputting, on the email client, the located one or more email addresses to the user.

9. The method of claim 1, further comprising:
in response to receiving the registration request from the user, registering the user with the email service provided by the email server; and
wherein providing the email address suggestion includes providing an email address suggestion to the user during email composition by searching for one or more suggested email addresses in the contact relevance data in the recipient cache without accumulating additional contact relevance data.

10. An email server implementing contact relevance data provisioning in an email system, the email server comprising:
a processor; and
a memory operatively coupled to the processor, the memory containing instructions executable by the processor to cause the email server to:
upon receiving an email message, create a database record in a reverse index database indexed to an email address of the received email message, the database record also containing one or more additional email addresses also contained in the detected email message; and
upon receiving a registration request from a user to register the indexed email address with an email service provided by the email server,
locate the created database record in the reverse index database using the indexed email address as a key;
provision contact relevance data in a recipient cache of the user by copying data in the located database record from the reverse index database to the recipient cache; and
output an email address suggestion to the user during email composition by searching for one or more suggested email addresses in the contact relevance data in the recipient cache, thereby reducing or eliminating delay in providing the email address suggestion.

11. The email server of claim 10 wherein:
the received email message contains (i) the email address as a source email address and (ii) a destination email address with a corresponding user in the email system, the source email address does not have a corresponding user in the email system; and
to create the record includes to create the record in the reverse index database indexed to the source email address of the email message, the record also containing one or more of the destination email address or an identification of the corresponding user of the destination email address.

12. The email server of claim 10 wherein:
the detected email message contains (i) the email address as a destination email address and (ii) a source email address with a corresponding user in the email system, the destination email address does not have a corresponding user in the email system; and
to create the record includes to create the record in the reverse index database indexed to the destination email address of the email message, the record also containing one or more of the source email address or an identification of the corresponding user of the source email address.

13. The email server of claim 10 wherein:
the received email message contains (i) the email address as a source email address and (ii) a destination email address, neither the source email address nor the destination email address have a corresponding user in the email system; and
to create the record includes:
to create a first record in the reverse index database indexed to the source email address of the email message, the first record also containing the destination email address; and
to create a second record in the reverse index database indexed to the destination email address of the email message, the second record also containing the source email address.

14. The email server of claim 10 wherein:
the detected email message is a first email message; and
the memory contains additional instructions executable by the processor to cause the email server to:
receive a second email message also containing the email address; and
in response to receiving the second email message, update the created record in the reverse index database indexed to the email address one or more other email addresses contained in the second email message.

15. The email server of claim 10 wherein the memory contains additional instructions executable by the processor to cause the email server to:
detect a user input to a destination address field in an email client interconnected to the email server; and
in response to detecting the user input, output, on the email client, the suggested email address for selection by the user.

16. The email server of claim 10 wherein the memory contains additional instructions executable by the processor to cause the email server to:
detect a user input to a destination address field in an email client interconnected to the email server, the user input includes one or more characters; and
in response to detecting the user input,
search the recipient cache to locate one or more email addresses containing the one or more characters; and
output, on the email client, the located one or more email addresses for selection by the user.

17. A method for contact relevance data provisioning in a communications system having one or more servers interconnected by a computer network, the method comprising:
detecting, at a server of the communications system, reception of a message having source and destination contact data identifying a source or destination of the received message;
in response to detecting the reception of the message, at the server,
determining whether at least one of the source or destination contact data corresponds to a registered user of the communications system;
in response to determining that at least one of the source or destination contact data does not correspond to a registered user of the communications system,
creating a record in a reverse index database indexed to the at least one of the source or destination contact data, the record also containing additional contact data also contained in the received message; and
upon receiving, at the server, a registration request from a user to create an account at the communications system using the at least one of the source or destination contact data,
copying data from the created record in the reverse index database to a recipient cache of the user as contact relevance data; and
providing a communications destination suggestion to the user using the contact relevance data in the recipient cache of the user without accumulating additional contact relevance data.

18. The method of claim 17 wherein:
detecting the reception of the message includes detecting a reception of an email message having an email address, a phone call having a phone number, or an instant message having a user alias; and
creating the record includes creating the record in the reverse index database indexed to the email address, phone number, or user alias.

19. The method of claim 17 wherein:
the source and destination contact data contains a source email address and a destination email address, respectively; and
creating the record includes:
creating a first record in the reverse index database indexed to the source email address; and
creating a second record in the reverse index database indexed to the destination email address.

20. The method of claim 17 wherein:
the source and destination contact data contains a source email address and a destination email address, respectively; and
creating the record includes:
creating a first record in the reverse index database indexed to the source email address; and
creating a second record in the reverse index database indexed to the destination email address; and
the first and second created records individually contain data representing one or more of a frequency or recency of communications between the source and destination addresses.
